(19) United States
(12) Patent Application Publication
(10) Pub. No.: US 2006/0019569 A1
(43) Pub. Date: Jan. 26, 2006

(54) Sound absorbing composite material

(75) Inventor: Ming-Yang Lin, Shan Shang Hsiang (TW)

Correspondence Address: NIKOLAI & MERSEREAU, P.A., 900 SECOND AVENUE SOUTH, SUITE 820, MINNEAPOLIS, MN, 55402, US

(73) Assignee: San Shiang Technology Co., Ltd., Tainan Hsien (TW)

(21) Appl. No.: 11/179,949

(22) Filed: Jul. 12, 2005

(30) Foreign Application Priority Data
Jul. 21, 2004 (TW) 093211519

(51) Int. Cl. B32B 27/04; B32B 5/26; B32B 27/12; B32B 5/02

(52) U.S. Cl. 442/381; 442/149; 442/120

(57) ABSTRACT

A sound-absorbing composite material includes a super thin fiber layer, and a non-woven fiber layer laminating the super thin fiber layer. Thus, the super thin fiber layer co-operates with the non-woven fiber layer to provide a better sound-absorbing effect, thereby enhancing the sound-absorbing effect of the sound-absorbing composite material. In addition, the super thin fiber layer is rested on and attached to the non-woven fiber layer which provides support to the super thin fiber layer to enhance the strength of the super thin fiber layer, so that the super thin fiber layer is not easily worn out when in use, thereby enhancing the lifetime of the sound-absorbing composite material.

### BACKGROUND OF THE INVENTION

1. Field of the Invention

The present invention relates to a sound-absorbing composite material, and more particularly to a sound-absorbing composite material that provides a better sound-absorbing effect.

2. Description of the Related Art

A sound-absorbing material is used to absorb the acoustic wave and to weaken the intensity or strength of the acoustic wave until the acoustic wave vanishes. The acoustic wave usually has a higher frequency, an intermediate frequency or a lower frequency, wherein the acoustic wave having a higher or an intermediate frequency easily causes an uncomfortable sensation to the people. However, the conventional sound-absorbing material has a better sound-absorbing effect to the acoustic wave having a higher frequency and also has a poor sound-absorbing effect to the acoustic wave having an intermediate frequency, or alternatively, has a better sound-absorbing effect to the acoustic wave having an intermediate frequency and also has a poor sound-absorbing effect to the acoustic wave having a higher frequency, thereby decreasing the sound-absorbing effect of the conventional sound-absorbing material.

### SUMMARY OF THE INVENTION

In accordance with the present invention, there is provided a sound-absorbing composite material, comprising a super thin fiber layer, and a non-woven fiber layer laminating the super thin fiber layer.

The primary objective of the present invention is to provide a sound-absorbing composite material that provides a better sound-absorbing effect.

Another objective of the present invention is to provide a sound-absorbing composite material, wherein the super thin fiber layer co-operates with the non-woven fiber layer to provide a better sound-absorbing effect, thereby enhancing the sound-absorbing effect of the sound-absorbing composite material.

A further objective of the present invention is to provide a sound-absorbing composite material, wherein the super thin fiber layer is rested on and attached to the non-woven fiber layer which provides support to the super thin fiber layer to enhance the strength of the super thin fiber layer, so that the super thin fiber layer is not easily worn out when in use, thereby enhancing the lifetime of the sound-absorbing composite material.

A further objective of the present invention is to provide a sound-absorbing composite material, wherein the sound-absorbing composite material also has a heat insulation effect.

A further objective of the present invention is to provide a sound-absorbing composite material, wherein the sound-absorbing composite material also has a shock-absorbing effect.

A further objective of the present invention is to provide a sound-absorbing composite material, wherein the sound-absorbing composite material also has a refractory effect.

Further benefits and advantages of the present invention will become apparent after a careful reading of the detailed description with appropriate reference to the accompanying drawings.

### BRIEF DESCRIPTION OF THE DRAWINGS

FIG. 1 is a plan cross-sectional view of a sound-absorbing composite material in accordance with the preferred embodiment of the present invention;

FIG. 2 is a schematic operational view of the sound-absorbing composite material as shown in FIG. 1 in use;

FIG. 3 is a plan cross-sectional view of a sound-absorbing composite material in accordance with another preferred embodiment of the present invention;

FIG. 4 is a plan cross-sectional view of a sound-absorbing composite material in accordance with another preferred embodiment of the present invention;

FIG. 5 is a plan cross-sectional view of a sound-absorbing composite material in accordance with another preferred embodiment of the present invention;

FIG. 6 is a plan cross-sectional view of a sound-absorbing composite material in accordance with another preferred embodiment of the present invention; and

FIG. 7 is a plan cross-sectional view of a sound-absorbing composite material in accordance with another preferred embodiment of the present invention.

### DETAILED DESCRIPTION OF THE INVENTION

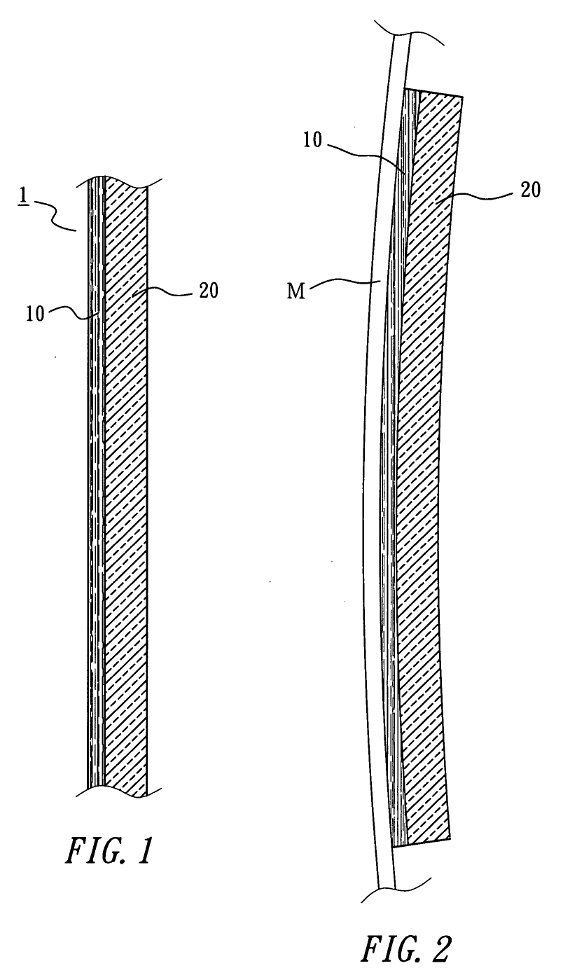

Referring to the drawings and initially to FIG. 1, a sound-absorbing composite material 1 in accordance with the preferred embodiment of the present invention comprises a super thin fiber layer 10, and a non-woven fiber layer 20 laminating the super thin fiber layer 10.

The super thin fiber layer 10 is a super thin fiber laminating layer formed by a sputtering process or a filament extrusion process. The super thin fiber layer 10 has a dimension substantially equal to or smaller than 0.7 Denier. The non-woven fiber layer 20 is a non-woven fiber laminating layer formed by a non-woven manufacturing process. The non-woven fiber layer 20 has a dimension substantially equal to or greater than 0.8 Denier. The super thin fiber layer 10 is combined with the non-woven fiber layer 20 by a bonding agent, an adhesive or by a heat melting connection process.

The super thin fiber layer 10 has a relatively smaller thickness so that the laminating thickness of the super thin fiber layer 10 is relatively smaller. In addition, the voids formed by the staggered winding fiber filaments of the super thin fiber layer 10 are relatively smaller, so that when the acoustic wave reaches the super thin fiber layer 10, the acoustic wave wholly enters the super thin fiber layer 10 without reflection. Thus, the super thin fiber layer 10 receives the acoustic wave wholly.

When the acoustic wave having a relatively greater frequency (smaller wavelength) enters the voids of the super thin fiber layer 10, the width of each of the voids of the super thin fiber layer 10 is closer to the wavelength of the acoustic wave to produce interruption action which breaks continuity of the acoustic wave and converts the dynamic energy of the acoustic wave into a frictional heat energy to reduce the intensity of the acoustic wave rapidly until the acoustic wave vanishes. Thus, most of the acoustic wave having a relatively greater frequency is directly absorbed by the super thin fiber layer 10. In addition, the sound-absorbing composite material has a better sound-absorbing effect when the thickness of the super thin fiber layer 10 is increased.

The non-woven fiber layer 20 has a relatively greater thickness so that the non-woven fiber layer 20 has greater laminating thickness, strength and void. Thus, the voids formed by the non-woven fiber layer 20 are available to receive the acoustic wave having a relatively intermediate frequency (intermediate wavelength). In fact, when the acoustic wave having a relatively intermediate frequency enters the super thin fiber layer 10, the intensity of the acoustic wave is weakened. Thus, after the acoustic wave having a relatively intermediate frequency enters the non-woven fiber layer 20, the width of each of the voids of the non-woven fiber layer 20 is closer to the wavelength of the acoustic wave, so that vibration of the acoustic wave and the fibers of the non-woven fiber layer 20 produce impact friction to convert the dynamic energy of the acoustic wave into a frictional heat energy to reduce the intensity of the acoustic wave rapidly until the acoustic wave vanishes. In addition, the sound-absorbing composite material has a better sound-absorbing effect when the thickness of the non-woven fiber layer 20 is increased.

Accordingly, the super thin fiber layer 10 co-operates with the non-woven fiber layer 20 to provide a better sound-absorbing effect, thereby enhancing the sound-absorbing effect of the sound-absorbing composite material. In addition, the super thin fiber layer 10 is rested on and attached to the non-woven fiber layer 20 which provides support to the super thin fiber layer 10 to enhance the strength of the super thin fiber layer 10, so that the super thin fiber layer 10 is not easily worn out when in use, thereby enhancing the lifetime of the sound-absorbing composite material.

Referring to FIG. 2, when the sound-absorbing composite material is mounted on a sheet metal “M”, the super thin fiber layer 10 has a surface bonded onto an inner face of the sheet metal “M”, so that the sound-absorbing composite material provides a better sound-absorbing effect to the sheet metal “M”. Preferably, the sound-absorbing composite material further comprises a refractory agent located between the super thin fiber layer 10 and the non-woven fiber layer 20 to provide a refractory effect.

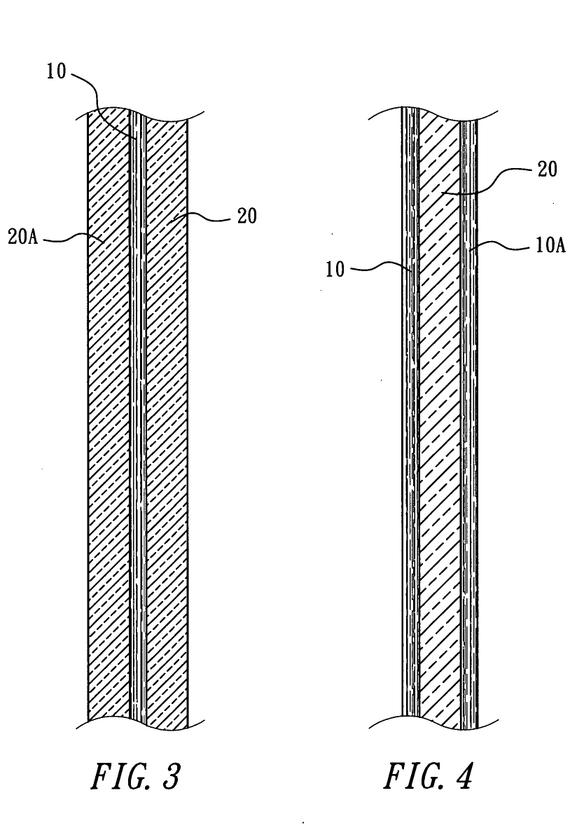

Referring to FIG. 3, the sound-absorbing composite material further comprises a secondary non-woven fiber layer 20A mounted on an outer surface of the super thin fiber layer 10 so that the super thin fiber layer 10 is sandwiched between the non-woven fiber layer 20 and the secondary non-woven fiber layer 20A. Thus, the sound-absorbing composite material has the same sound-absorbing effect with greater strength and enhanced lifetime.

Referring to FIG. 4, the sound-absorbing composite material further comprises a secondary super thin fiber layer 10A mounted on an outer surface of the non-woven fiber layer 20 so that the non-woven fiber layer 20 is sandwiched between the super thin fiber layer 10 and the secondary super thin fiber layer 10A. Thus, the sound-absorbing composite material has a better sound-absorbing effect.

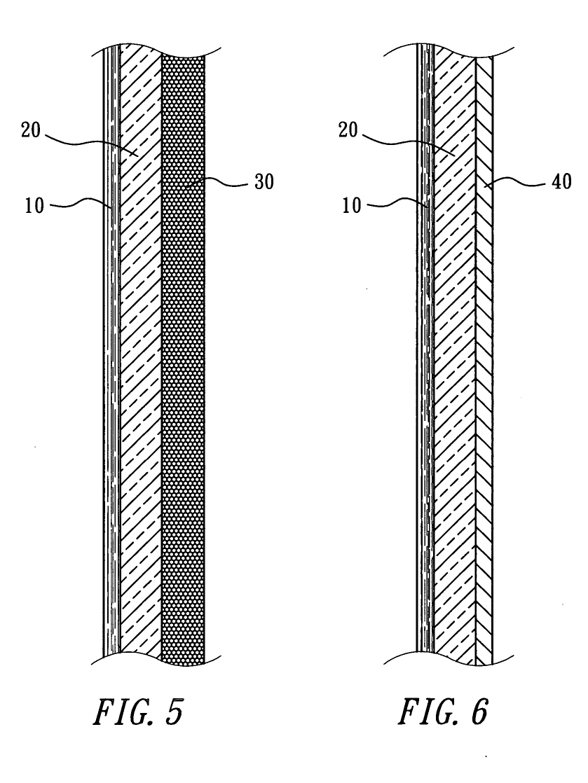

Referring to FIG. 5, the sound-absorbing composite material further comprises a foamable layer 30 mounted on an outer surface of the non-woven fiber layer 20 so that the non-woven fiber layer 20 is sandwiched between the super thin fiber layer 10 and the foamable layer 30. Thus, the sound-absorbing composite material has a better sound-absorbing effect.

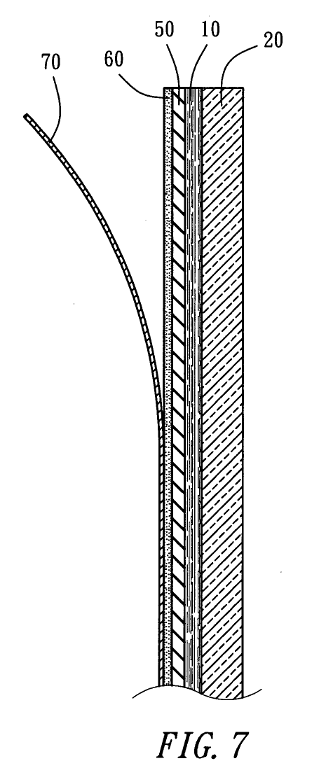

Referring to FIG. 6, the sound-absorbing composite material further comprises an aluminum foil layer 40 mounted on an outer surface of the non-woven fiber layer 20 so that the non-woven fiber layer 20 is sandwiched between the super thin fiber layer 10 and the aluminum foil layer 40. Thus, the sound-absorbing composite material also has a heat insulation effect.

Referring to FIG. 7, the sound-absorbing composite material further comprises a shock-absorbing cushion 50 mounted on an outer surface of the super thin fiber layer 10, a bonding gel 60 mounted on an outer surface of the shock-absorbing cushion 50, and a releasing paper 70 mounted on an outer surface of the bonding gel 60. In practice, after the releasing paper 70 is removed from the bonding gel 60, the shock-absorbing cushion 50 is bonded by the bonding gel 60 onto an inner face of an object, such as a sheet metal, thereby attaching the sound-absorbing composite material to the sheet metal. Thus, the sound-absorbing composite material also has a shock-absorbing effect.

Although the invention has been explained in relation to its preferred embodiment(s) as mentioned above, it is to be understood that many other possible modifications and variations can be made without departing from the scope of the present invention. It is, therefore, contemplated that the appended claim or claims will cover such modifications and variations that fall within the true scope of the invention.

What is claimed is:

1. A sound-absorbing composite material, comprising:
a super thin fiber layer;
a non-woven fiber layer laminating the super thin fiber layer.

2. The sound-absorbing composite material in accordance with claim 1, wherein the super thin fiber layer has a dimension substantially equal to or smaller than 0.7 Denier.

3. The sound-absorbing composite material in accordance with claim 1, wherein the non-woven fiber layer has a dimension substantially equal to or greater than 0.8 Denier.

4. The sound-absorbing composite material in accordance with claim 1, wherein the super thin fiber layer is combined with the non-woven fiber layer by a bonding agent or an adhesive.

5. The sound-absorbing composite material in accordance with claim 1, wherein the super thin fiber layer is rested on and attached to the non-woven fiber layer which provides support to the super thin fiber layer to enhance the strength of the super thin fiber layer.

6. The sound-absorbing composite material in accordance with claim 1, wherein the super thin fiber layer has a surface bonded onto an inner face of an object.

7. The sound-absorbing composite material in accordance with claim 1, further comprising a secondary non-woven fiber layer mounted on an outer surface of the super thin fiber layer so that the super thin fiber layer is sandwiched between the non-woven fiber layer and the secondary non-woven fiber layer.

8. The sound-absorbing composite material in accordance with claim 1, further comprising a secondary super thin fiber layer mounted on an outer surface of the non-woven fiber layer so that the non-woven fiber layer is sandwiched between the super thin fiber layer and the secondary super thin fiber layer.

9. The sound-absorbing composite material in accordance with claim 1, further comprising a foamable layer mounted on an outer surface of the non-woven fiber layer so that the non-woven fiber layer is sandwiched between the super thin fiber layer and the foamable layer.

10. The sound-absorbing composite material in accordance with claim 1, further comprising an aluminum foil layer mounted on an outer surface of the non-woven fiber layer so that the non-woven fiber layer is sandwiched between the super thin fiber layer and the aluminum foil layer.

11. The sound-absorbing composite material in accordance with claim 1, further comprising a shock-absorbing cushion mounted on an outer surface of the super thin fiber layer.

12. The sound-absorbing composite material in accordance with claim 11, further comprising a bonding gel mounted on an outer surface of the shock-absorbing cushion, and a releasing paper mounted on an outer surface of the bonding gel.
